(19) United States
(12) Patent Application Publication
(10) Pub. No.: US 2026/0061379 A1
(43) Pub. Date: Mar. 5, 2026

(54) Water Distribution Regulation Method for Reclaimed Waterway Landscape Environments Based on Algae Risk Control

(71) Applicant: Zhejiang Institute of Hydraulics & Estuary (Zhejiang Institute of Marine Planning and Design), Hangzhou (CN)

(72) Inventors: Junmin WANG, Hangzhou (CN); Lei FU, Hangzhou (CN); Hui WU, Hangzhou (CN); Yue ZHANG, Hangzhou (CN); Aiju YOU, Hangzhou (CN); Hongxi PENG, Hangzhou (CN); Yujia ZHOU, Hangzhou (CN); Chao JIANG, Hangzhou (CN); Lei HUA, Hangzhou (CN)

(21) Appl. No.: 19/313,895

(22) Filed: Aug. 29, 2025

(30) Foreign Application Priority Data
Sep. 2, 2024 (CN) 202411220516.7

(51) Int. Cl. B01F 35/21; B01F 35/22; B01F 101/00; C02F 1/00; C02F 103/00; G06Q 30/018

(52) U.S. Cl. CPC B01F 35/2132; B01F 35/2209; C02F 1/008; G06Q 30/018; B01F 2101/305; C02F 2103/007; C02F 2209/16; C02F 2209/18

(57) ABSTRACT

A water distribution regulation method for reclaimed waterway landscape environment based on algae risk control, comprising: according to the water source characteristics of seasonal river landscape environment water and the hydraulic characteristics of river water, based on the algae growth curve of indicative algae species, controlling algae risk with nitrogen-phosphorus ratio and water replacement rate as control indicators; based on the nitrogen-phosphorus ratio and water replacement rate, constructing a joint regulation model for water-quantity and water-quality of the river incorporating reclaimed water; based on the joint regulation model, optimizing the nitrogen-phosphorus ratio of the river water environment with the indicative algae species; based on the optimized nitrogen-phosphorus ratio, optimizing the joint regulation model; and utilizing the optimized joint regulation model to perform joint regulation of water quantity and water quality.

### CROSS-REFERENCE TO RELATED APPLICATIONS

The present disclosure claims priority of Chinese Patent Application No. 202411220516.7, filed on Sep. 2, 2024, the entire contents of which are hereby incorporated by reference.

### TECHNICAL FIELD

The present disclosure relates to technical field of water resource and water ecological environment, and particularly to a water distribution regulation method for reclaimed waterway landscape environment based on algae risk control.

### BACKGROUND

Reclaimed water is used to replenish landscape environment water for urban rivers, which not only solves the problem of seasonal insufficient landscape environment water in rivers but also alleviates the pressure on river and lake ecological environments caused by the discharge of water from sewage treatment plants. Additionally it is a key focus of reclaimed water utilization. Indeed, the seasonal rivers exhibit huge variations in water quantity and quality within and between years, while the reclaimed water quality standards for landscape environment water are not high, therefore, the reclaimed water used for river landscape environment water allocation and the risk of algae outbreaks due to eutrophication deserve attention. Previous studies have shown that during the eutrophication process of landscape water, there are many factors influencing algae reproduction, among which nitrogen and phosphorus nutrients rank top in their influence on algae growth; the ratio of total nitrogen (TN) to total phosphorus (TP) (nitrogen-phosphorus ratio) is the main parameter controlling algae growth.

Regarding the use of reclaimed water for landscape environment water allocation, application numbers CN202410143623.8, 202311068310.2, 202222719485.2, 202210647108.4, 202122296722.4, and 201811214451.X have respectively disclosed a number of reclaimed water treatment technologies and apparatuses, and application Nos. 202210132749.6, 202110448592.3, 202010681227.2, 201610475813.5, 202210198200.7, 202110317690.3, 201210120358.9, 201910274823.6, and 202310918375.5 have disclosed a number of optimization technologies, scheduling, and management methods for reclaimed water used in landscape environment water replenishment. These achievements have not considered the algae risk control issue of reclaimed water utilization, either have not involved the regulatory technologies and methods coupling the seasonal river water quantity and water quality variation characteristics with reclaimed water, which results in varying degrees of river water quality degradation and abnormal algae reproduction after reclaimed water diversion and allocation in some regions.

### SUMMARY

To solve the above technical problems, the embodiments of the present disclosure provide a water distribution regulation method for reclaimed waterway landscape environment based on algae risk control to address the technical issues in related technologies of not considering the algae risk control issue of reclaimed water utilization and not involving the regulatory technologies coupling the seasonal river water quantity and water quality variation characteristics with reclaimed water.

According to the embodiments of the present disclosure, there is provided a water distribution regulation method for reclaimed waterway landscape environment based on algae risk control, including:
According to water source characteristics of seasonal river landscape environment water and hydraulic characteristics of river water, based on a algae growth curve of indicative algae species, controlling algae risk with a nitrogen-phosphorus ratio and a water replacement rate as control indicators, the nitrogen-phosphorus ratio serving as the control indicator for a free-flow segment of the river and the water replacement rate serving as the control indicator for a backwater segment of the river regulated by an overflow weir dam;
Based on the nitrogen-phosphorus ratio and the water replacement rate, constructing a joint regulation model for water-quantity and water-quality of the river incorporating reclaimed water, the joint regulation model for water-quantity and water-quality of the river incorporating reclaimed water being composed of an objective function and constraint conditions, the objective function including an algae risk control objective and a river flow or water quantity objective, the constraint conditions including a usable quantity constraint of surface water resources within a basin and a usable quantity constraint of the reclaimed water;
Based on the joint regulation model for water-quantity and water-quality of the river incorporating reclaimed water, optimizing the nitrogen-phosphorus ratio of the river water environment with the indicative algae species;
Based on the optimized nitrogen-phosphorus ratio, optimizing the joint regulation model for water-quantity and water-quality of the river incorporating reclaimed water;
Utilizing the optimized joint regulation model for water-quantity and water-quality of the river incorporating reclaimed water to perform joint regulation of water quantity and water quality.

Optionally, the algae risk control objective is:

$$α = \frac{{D}_{TN}}{{D}_{TP}} = [ {α}_{1} , {α}_{2} ] ;$$

$$T = \frac{{W}_{0}}{{w}_{1} + {w}_{2}} = [ {T}_{1} , {T}_{2} ] ;$$

where α is a nitrogen-phosphorus ratio in the river segment water; [symbol] D_{TP} are a total nitrogen concentration and a total phosphorus concentration values in the river segment water, respectively; [symbol] α₂ are a lower limit and a upper limit of a reasonable interval of the nitrogen-phosphorus ratio for controlling algae growth; T is a water replacement period of the backwater area; W₀ is a volume of the backwater area; [symbol] w₂ are respectively unit-time replenishment volumes of surface water within the basin and the reclaimed water for the backwater area; [symbol] T₂ are respectively a lower limit and upper limit of the reasonable interval for the water replacement period of the backwater area.

Optionally, the river flow or water quantity objective is:

$${Q}_{R} \geq {Q}_{OBJ} = max [ {Q}_{L} , {Q}_{E} ] ;$$

$${w}_{R} \geq {w}_{OBJ} = max [ {w}_{L} , {w}_{E} ] ;$$

where Q_{R} is a flow rate of the river segment water; Q_{OBJ} is a target flow rate of the river segment water; [symbol] Q_{E} are a landscape flow rate and an environmental flow rate of the river segment water, respectively; w_{R} is a water level of the backwater area; w_{OBJ} is a target water level of the backwater area; [symbol] w_{E} are respectively a landscape water level and an environmental water level of the backwater area.

Optionally, the usable quantity constraint of surface water resources within the basin and the usable quantity constraint of the reclaimed water are respectively:

Usable quantity constraint of surface water resources within the basin:

$${Q}_{R 1} ( t ) \leq {Q}_{R 1}^{0} ( t ) ;$$

Usable quantity constraint of the reclaimed water:

$${Q}_{R 2} ( t ) \leq {Q}_{R 2}^{0} ( t ) ;$$

where Q_{R1}(t) [symbol] Q_{R2}(t) are respectively a replenishment flow rates of surface water within the basin and a reclaimed water during the t period;

$${Q}_{R 1}^{0} ( t ) , {Q}_{R 2}^{0} ( t )$$

are a upper limits of the usable quantities of surface water within the basin and a reclaimed water during the t period, respectively.

Optionally, when solving the objective function, it is necessary to use three models consisting of a watershed water resource quantity and a non-point source pollution load calculation model, a river water quality and ecological coupling model, and a water quantity balance model, the three models being constrained by the constraint conditions, wherein the watershed water resource quantity and non-point source pollution load calculation model is constructed using SWMM software, and the river water quality and ecological coupling model and the water quantity balance model are constructed using WASP5;

Employing SWMM software to calibrate parameters of the established watershed water resource quantity and non-point source pollution load model using monitoring data;

Employing WASP5 software to calibrate parameters of the established river water quality and ecological coupling model using monitoring data until a difference between the simulated and calculated values of the model and the monitoring values is less than a first threshold.

Optionally, monitoring data are used to simulate operation of the river landscape environment system with the optimized joint regulation model for water-quantity and water-quality of the river incorporating reclaimed water, simulated operation results are compared with the monitoring data, and when a deviation is less than a second threshold, the model is considered feasible, otherwise returning to parameter calibration.

Optionally, based on the joint regulation model for water-quantity and water-quality of the river incorporating reclaimed water, for optimizing the nitrogen-phosphorus ratio of the river water environment with the indicative algae species:
Collecting natural river water source and collecting reclaimed water source;
Performing total nitrogen concentration and total phosphorus concentration detection on the natural river water source and the collected reclaimed water source;
According to the results of the total nitrogen concentration and total phosphorus concentration detection, carrying out single water source cultivation and mixed water source cultivation of algae, obtaining algae growth curves, and simultaneously analyzing influence of absorbance on algae growth;
Considering the algae growth curves and the influence of absorbance on algae growth and combining actual situation of a river using reclaimed water as the diversion water source, based on hydrodynamic and water quality calculation formulas, aiming at inhibiting algae growth and meeting a river water allocation volume, calculating the nitrogen-phosphorus ratio of river water and reclaimed water after mixing them in different proportions;
Taking nitrogen-phosphorus ratios N:P of 0:1, 5:1, 10:1, 16:1, 40:1 as standard theoretical interval values, taking N:P=16:1 and N:P=40:1 as the lower critical value and upper critical value for judging the inhibition of algal cell growth, repeating the above steps until the targets in the objective function are achieved.

Optionally, during the single water source cultivation and mixed water source cultivation processes, cultivation conditions are set as temperature of 30° C., illumination of 2000 LUX, and a light-dark ratio of 12 h: 12 h.

The technical solutions provided by the embodiments of the present disclosure include the following beneficial effects:

As can be seen from the above embodiments, while utilizing reclaimed water to replenish seasonal river landscape environment water, the present disclosure overcomes technical problems such as river water quality degradation and abnormal algae reproduction that may occur after reclaimed water is used for river landscape environment water allocation, thereby achieving the technical effects of rational allocation and precise regulation of multi-source water for seasonal rivers, further realizing the synchronous regulation objectives of algae risk control and river water quantity, and furthermore achieving optimized allocation of usable quantities of surface water resources within the basin and reclaimed water.

It should be understood that the above general descriptions and the detailed descriptions below are merely exemplary and explanatory and cannot limit the present disclosure.

### BRIEF DESCRIPTION OF DRAWINGS

The drawings herein are incorporated into the specification and constitute a part thereof, illustrating embodiments conforming to the present disclosure and used together with the specification to explain the principles of the present disclosure.

FIG. 1 is a schematic diagram of an implementation object according to an exemplary embodiment.

FIG. 2 is a flowchart of water distribution regulation method for reclaimed waterway landscape environment based on algae risk control according to an exemplary embodiment.

FIG. 3 is a diagram showing the influence of different proportions of mixed water on the growth density of different algae according to an exemplary embodiment.

FIG. 4 is a diagram showing the influence of different proportions of mixed water on the growth status of different algae according to an exemplary embodiment.

FIG. 5 is a schematic diagram of the watershed runoff generation and concentration system based on SWMM software according to an exemplary embodiment.

FIGS. 6a to 6d show model parameter validation process comparison diagrams according to an exemplary embodiment.

FIGS. 7a to 7e show an ecological model chlorophyll-a validation process according to an exemplary embodiment.

### DESCRIPTION OF EMBODIMENTS

Hereinafter, exemplary embodiments will be described in detail, the examples of which are shown in the drawings. The following description involves the drawings, and unless otherwise indicated, the same numbers in different drawings refer to the same or similar elements. The implementation modes described in the following exemplary embodiments do not represent all implementation modes consistent with the present disclosure. Instead, they are only examples of devices and methods consistent with some aspects of the present disclosure as detailed in the appended claims.

Water distribution regulation method for reclaimed waterway landscape environment based on algae risk control provided in the embodiments of the present disclosure relies on an engineering system for using reclaimed water in seasonal river landscape environment water allocation, the engineering system includes a reclaimed water plant, a reclaimed water supply pipe network, and a river overflow weir dam; the river overflow weir dam regulates and stores multiple water sources to form a certain inundation range to meet landscape requirements. Regulation of water quantity and water quality perception can be collected through the following facilities, including but not limited to water quantity and water quality monitoring facilities of the reclaimed water plant, water quantity detection facilities of the reclaimed water supply pipe network, precipitation monitoring facilities within the watershed where the seasonal river is located, and water quantity and water quality monitoring facilities within the river.

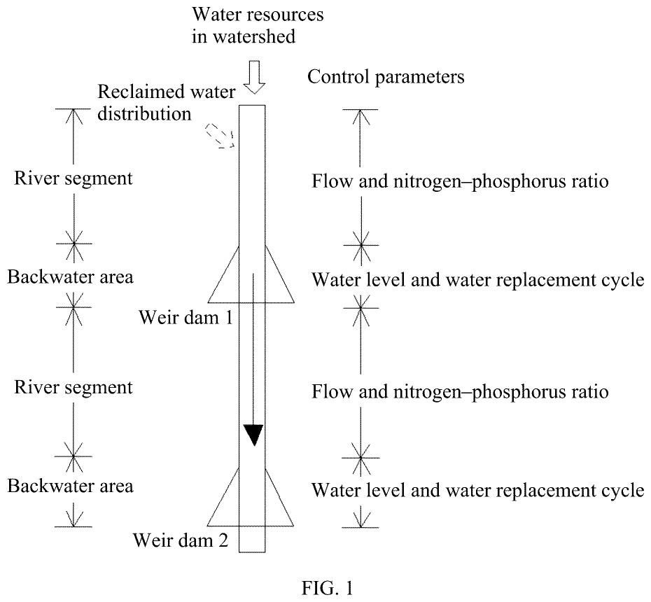

FIG. 1 is a schematic diagram of an implementation object according to an exemplary embodiment. A river with an overflow weir dam for regulation and storage is subjected to landscape environment water allocation in reclaimed water rivers based on algae risk control with nitrogen-phosphorus ratio and water replacement rate as control indicators. This embodiment takes a seasonal urban river in a county-level city in central Zhejiang as a case study, which perennially suffers from insufficient water volume during dry periods, severe shortages of landscape environment water, resulting in water environmental quality failing to meet expectations and a large gap with the overall objectives of urban construction. The seasonal urban river has a catchment area of 24 km², located in the central urban area, with insufficient landscape environment water within the basin, solved through precise allocation of reclaimed water.

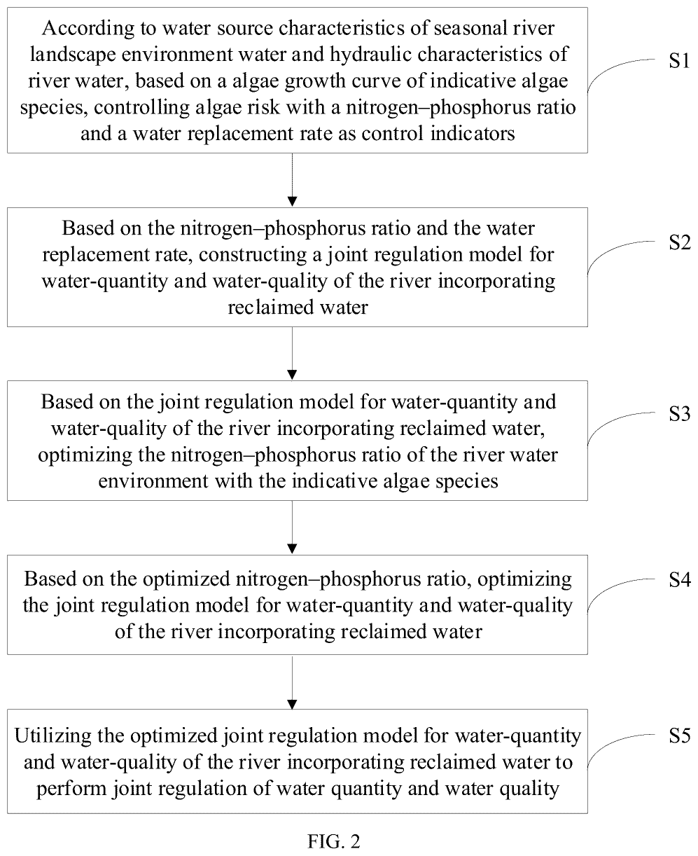

FIG. 2 is a flowchart of water distribution regulation method for reclaimed waterway landscape environment based on algae risk control according to an exemplary embodiment, as shown in FIG. 2, the method may include the following steps:
S1: According to the water source characteristics of seasonal river landscape environment water and the hydraulic characteristics of river water, based on the algae growth curve of indicative algae species, controlling algae risk with nitrogen-phosphorus ratio and water replacement rate as control indicators, the nitrogen-phosphorus ratio serving as the control indicator for the free-flow segment of the river and the water replacement rate serving as the control indicator for the backwater segment of the river regulated by an overflow weir dam;
Specifically, according to the water source characteristics of seasonal river landscape environment water and the hydraulic characteristics of river water, using Microcystis aeruginosa and Chlorella as indicative algae species, to determine the algae growth curves of the indicative algae species.

According to the algae growth curves of the indicative algae species, when phosphorus nutrients are sufficient, a nitrogen-phosphorus ratio of 45:1 is the optimal condition for Microcystis growth; when the phosphorus concentration of reclaimed water is below 0.1 mg/L, water allocation can be maximized to avoid cutrophication of the river; when the phosphorus concentration of reclaimed water is above 0.1 mg/L, the decision on whether to allocate water should be made in conjunction with the actual nitrogen-phosphorus conditions of river water and reclaimed water. Experimental results are in good agreement with related literature results.

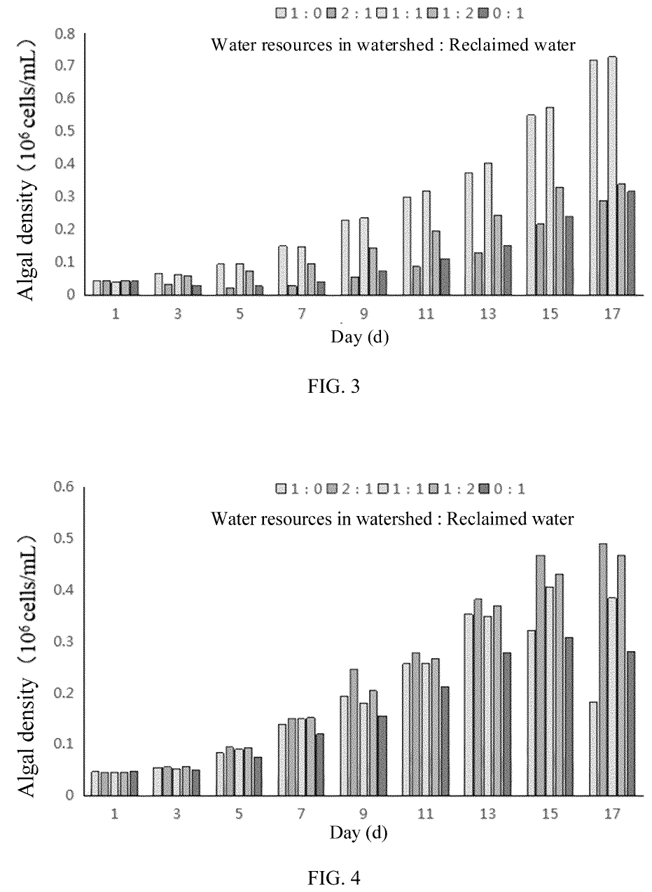

FIG. 3 and FIG. 4 show the influence of different source proportions on the algal densities of Microcystis and Chlorella, wherein the water resources in the watershed is reclaimed water, with ratios of river water to reclaimed water are, from left to right, 1:0, 2:1, 1:1, 1:2, 0:1. Microcystis aeruginosa and Chlorella grow best and have the fastest growth rates when the ratio of river water to reclaimed water is 1:1 and 2:1. Through analysis of the average specific growth rate, it can be concluded that the ratios of 1:2 and 0:1 are the least suitable for the growth of Microcystis and Chlorella. To control harmful algal blooms like Microcystis, it is recommended to allocate as much water as possible to the river under permissible conditions.

The maximum specific growth rate of Microcystis aeruginosa occurs around day 3, and the maximum specific growth rate of Chlorella occurs around days 5-7. To effectively suppress the occurrence of cyanobacterial blooms in the west river, during prolonged periods without rainfall runoff, the water allocation cycle should not exceed 3 to 6 days, and the 3-day water replacement rate should not be less than 75%.
S2: Based on the nitrogen-phosphorus ratio and the water replacement rate, constructing a joint regulation model for water-quantity and water-quality of the river incorporating reclaimed water, the joint regulation model for water-quantity and water-quality of the river incorporating reclaimed water being composed of an objective function and constraint conditions, the objective function including an algae risk control objective and a river flow or water quantity objective, the constraint conditions including a usable quantity constraint of surface water resources within a basin and a usable quantity constraint of the reclaimed water;

Specifically, the joint regulation model for water-quantity and water-quality of the river incorporating reclaimed water is composed of an objective function and constraint conditions.

### 1) Objective Function:

1.1) Algae Risk Control Objective: Under the condition that reclaimed water quality meets landscape environment water quality requirements, the ratio of total nitrogen concentration to total phosphorus concentration in the river segment water is controlled within a reasonable range; the water replacement rate (or water replacement period) ratio in the backwater area is controlled within a reasonable range.

The algae risk control objective is:

$$α = \frac{{D}_{TN}}{{D}_{TP}} = [ {α}_{1} , {α}_{2} ] ;$$

$$T = \frac{{W}_{0}}{{w}_{1} + {w}_{2}} = [ {T}_{1} , {T}_{2} ] ;$$

where α is the nitrogen-phosphorus ratio in the river segment water; [symbol] D_{TP} are the total nitrogen concentration and total phosphorus concentration values in the river segment water (mg/L), respectively; [symbol] α₂ are the lower limit and upper limit of the reasonable interval of the nitrogen-phosphorus ratio for controlling algae growth; T is the water replacement period of the backwater area (d); W₀ is the volume of the backwater area (m³); [symbol] w₂ are the unit-time replenishment volumes of surface water within the basin and reclaimed water for the backwater area (m³/d); [symbol] T₂ are the lower limit and upper limit of the reasonable interval for the water replacement period of the backwater area (d).

1.2) River Flow or Water Quantity Objective: For the river segment water, a target flow rate is taken, with the target flow rate being not less than the larger of the landscape flow rate and the environmental flow rate; for the backwater area, a target water level is taken, with the target water level being not less than the larger of the landscape water level and the ecological water level.

The river flow or water quantity objective is:

$${Q}_{R} \geq {Q}_{OBJ} = max [ {Q}_{L} , {Q}_{E} ] ;$$

$${w}_{R} \geq {w}_{OBJ} = max [ {w}_{L} , {w}_{E} ] ;$$

where Q_{R} is respectively flow rate of the river segment water (m³/s); Q_{OBJ} is the target flow rate of the river segment water (m³/s); [symbol] Q_{E} are the landscape flow rate and environmental flow rate of the river segment water (m³/s); wp is the water level of the backwater area (m); w_{OBJ} is the target water level of the backwater area (m); [symbol] w_{E} are the landscape water level and environmental water level of the backwater area (m), respectively.

1.3) An economic objective may also be considered: Under the condition that water quantity and water quality meet requirements, the operating cost of the reclaimed water system is minimized.

$$F = min ( c \times \sum {w}_{2} ) ;$$

where F is the operating cost of the reclaimed water system (Yuan); c is the operating cost per unit volume of reclaimed water (Yuan/m³); Σw₂ is the total utilization volume of reclaimed water (m³).

### 2) Constraint Conditions:

The usable quantity constraint of surface water resources within the basin and the usable quantity constraint of the reclaimed water are respectively:

Usable quantity constraint of surface water resources within the basin:

$${Q}_{R 1} ( t ) \leq {Q}_{R 1}^{0} ( t ) ;$$

Usable quantity constraint of the reclaimed water:

$${Q}_{R 2} ( t ) \leq {Q}_{R 2}^{0} ( t ) ;$$

In the formulas: Q_{R1}(t) [symbol] Q_{R2}(t) are the replenishment flow rates of surface water within the basin and reclaimed water during the t period (m³/s);

$${Q}_{R 1}^{0} ( t ) , {Q}_{R 2}^{0} ( t )$$

are the upper limits of the usable quantities of surface water within the basin and reclaimed water during the t period (m³/s).

When solving the objective function, it is necessary to use a watershed water resource quantity and non-point source pollution load calculation model, a river water quality and ecological coupling model, and a water quantity balance model, the three models being constrained by the constraint conditions, wherein the watershed water resource quantity and non-point source pollution load calculation model is constructed using SWMM software, and the river water quality and ecological coupling model and the water quantity balance model are constructed using WASP5;

Employing the SWMM software to calibrate the parameters of the established watershed water resource quantity and non-point source pollution load model using monitoring data; employing WASP5 software to calibrate the parameters of the established river water quality and ecological coupling model using monitoring data until the difference between the simulated and calculated values of the model and the monitoring values is less than a first threshold (for example, 15%).

Wherein the watershed water resource quantity and non-point source pollution load calculation model:

The watershed water resource quantity model characterizes the inflow process of runoff generated from each sub-basin converging to the stormwater outlet, using a non-linear reservoir model to describe the surface runoff process, each sub-catchment being generalized as a shallow non-linear reservoir, rainfall as input, soil infiltration and surface runoff as output, solved jointly by the continuity equation and Manning's formula:

$$\frac{dV}{dt} = A * \frac{dd}{dt} = A * {i}^{′} - {Q}_{o}$$

$${Q}_{o} = W * \frac{1.49}{n} * {( d - {d}_{p} )}^{5 / 3} * {S}^{1 / 2}$$

where V is the total water volume of the sub-catchment (m³); d is the surface water depth of the sub-catchment (m); A is the area of the sub-catchment (m²); t is rainfall time(s); i′ is net rainfall intensity (mm); Qₒ is runoff flow rate (m³/s); W is the characteristic width of the sub-catchment (m); n is the Manning coefficient; S is the slope of the sub-catchment.

The non-point source pollution load model characterizes non-point source pollution generated by rainfall runoff within the watershed, solved by the following equation:

$${M}_{0} = {Q}_{0} {C}_{0}$$

In the formula: Mₒ is the total non-point source pollution load of a specific pollutant in the area (t); Cₒ is the concentration of non-point source pollution of a specific pollutant in the area (mg/L).

Wherein the river water quality and ecological coupling model:

The river water quality and ecological model uses the following equations to solve for the main indicators respectively:

$$\begin{matrix}Carbonaceous biochemical oxygen demand & \\ \frac{\partial {C}_{5}}{\partial t} = {a}_{oc} {k}_{1 D} {C}_{4} - {k}_{d} {{θ}_{d}}^{( T - 20 )} ( \frac{{C}_{6}}{{K}_{BOD} + {C}_{6}} ) {C}_{5} - \frac{{v}_{s 3} ( 1 - {f}_{D 5} )}{H} {C}_{5} - \frac{5}{4} \frac{32}{14} {k}_{2 D} {{θ}_{2 D}}^{( T - 20 )} ( \frac{{k}_{{NO}_{3}}}{{k}_{{NO}_{3}} + {C}_{6}} ) {C}_{2} + \frac{{v}_{s 3} ( 1 - {f}_{D 5} )}{D} {C}_{5} - \frac{{v}_{R 3} ( 1 - {f}_{D 5 j} )}{D} {C}_{5 j} + \frac{{E}_{DIF}}{{D}^{2}} ( {C}_{5} {f}_{D 5} - {C}_{5 j} {f}_{D 5 j} ) & \end{matrix}$$

In the formulas: C is the concentration of a specific indicator (mg/L), t is the time(s), k is the mineralization rate of the specific indicator, K is the diffusion coefficient of the specific indicator (m²/s), θ is the temperature coefficient of the specific indicator (° C./s), f is the dissolution rate of the specific indicator (mol/L), BOD is biochemical oxygen demand (mg/L); in addition, the terms in the above formula respectively represent phytoplankton death, carbon oxidation, particle settling, denitrification, organic matter settling, suspension, and dispersion.

$$\begin{matrix}Dissolved oxygen & \\ \frac{\partial {C}_{6}}{\partial t} = {k}_{2} ( {C}_{S} - {C}_{6} ) - {k}_{d} {{θ}_{d}}^{( T - 20 )} ( \frac{{C}_{6}}{{K}_{BOD} + {C}_{6}} ) {C}_{5} - \frac{64}{14} {k}_{12} {{θ}_{12}}^{( T - 20 )} ( \frac{{C}_{6}}{{k}_{NIT} + {C}_{6}} ) {C}_{1} - \frac{SOD}{H} {θ}_{S}^{( T - 20 )} + {G}_{P 1} [ \frac{32}{12} + \frac{48}{14} \frac{14}{12} ( 1 - {P}_{{NH}_{3}} ) ] {C}_{4} - \frac{32}{12} {k}_{1 R} {θ}_{1 R} {C}_{4} & \end{matrix}$$

The units of the parameters in the formulas are the same as those in the above formulas; in addition, the terms in the above formula respectively represent reoxygenation, carbon oxidation, nitrification, sediment oxygen demand, growth, and respiration.

$$\begin{matrix}Ammonia nitrogen cycle equation & \\ \frac{\partial {C}_{1}}{\partial t} = {D}_{P 1} {a}_{NC} ( 1 - {f}_{ON} ) {C}_{4} + {k}_{71} {{θ}_{71}}^{( T - 20 )} ( \frac{{C}_{4}}{{k}_{mpc} + {C}_{4}} ) {C}_{7} - {G}_{P 1} {a}_{NC} {P}_{{NH}_{3}} {C}_{4} - {k}_{12} {{θ}_{12}}^{( T - 20 )} ( \frac{{C}_{6}}{{k}_{NIT} + {C}_{6}} ) {C}_{1} & \end{matrix}$$

The units of the parameters in the formula are the same as those in the above formulas; in addition, the terms in the above formula respectively represent phytoplankton death, mineralization, phytoplankton growth, and nitrification.

$$\begin{matrix}Nitrate nitrogen cycle equation & \\ \frac{\partial {C}_{2}}{\partial t} = {k}_{12} {{θ}_{12}}^{( T - 20 )} ( \frac{{C}_{6}}{{k}_{NIT} + {C}_{6}} ) {C}_{1} - {G}_{P 1} {a}_{NC} ( 1 - {P}_{{NH}_{3}} ) {C}_{4} - {k}_{2 D} {{θ}_{2 D}}^{( T - 20 )} ( \frac{{k}_{{NO}_{3}}}{{k}_{{NO}_{3}} + {C}_{4}} ) {C}_{2} & \end{matrix}$$

The units of the parameters in the formula are the same as those in the above formulas; in addition, the terms in the above formula respectively represent nitrification, phytoplankton growth, and denitrification.

$$\begin{matrix}Organic nitrogen cycle equation & \\ \frac{\partial {C}_{7}}{\partial t} = {D}_{P 1} {a}_{NC} {f}_{ON} {C}_{4} - {k}_{71} {{θ}_{71}}^{( T - 20 )} ( \frac{{C}_{4}}{{k}_{mpc} + {C}_{4}} ) {C}_{7} - \frac{{v}_{s 3} ( 1 - {f}_{D 7} )}{H} {C}_{7} & \end{matrix}$$

The units of the parameters in the formula are the same as those in the above formulas; in addition, the terms in the above formula respectively represent phytoplankton death, mineralization, and organic matter deposition.

$$\begin{matrix}Inorganic phosphorus ( {PO}_{4} ) cycle & \\ \frac{\partial {C}_{3}}{\partial t} = {D}_{P 1} {a}_{PC} ( 1 - {f}_{OP} ) {C}_{4} + {k}_{83} {θ}_{83}^{( T - 20 )} ( \frac{{C}_{4}}{{k}_{mpc} + {C}_{4}} ) {C}_{8} - {G}_{p 1} {a}_{pc} {C}_{4} & \end{matrix}$$

The units of the parameters in the formula are the same as those in the above formulas; in addition, the terms in the above formula respectively represent phytoplankton death, mineralization, and phytoplankton growth.

$$\begin{matrix}Organic phosphorus ( OP ) cycle & \\ \frac{\partial {C}_{8}}{\partial t} = {D}_{P 1} {a}_{PC} {f}_{OP} {C}_{4} + {k}_{83} {θ}_{83}^{( T - 20 )} ( \frac{{C}_{4}}{{k}_{mpc} + {C}_{4}} ) {C}_{8} - \frac{{v}_{S 3} ( 1 - {f}_{D 8} )}{H} {C}_{8} & \end{matrix}$$

The units of the parameters in the formula are the same as those in the above formulas; in addition, the terms in the above formula respectively represent phytoplankton death, mineralization, and deposition.

$$\begin{matrix}Phytoplankton nitrogen cycle & \\ \frac{\partial {C}_{4} {a}_{nc}}{\partial t} = {G}_{p 1} {a}_{nc} {C}_{4} - {D}_{p 1} {a}_{nc} {C}_{4} - \frac{{V}_{s 4}}{D} {a}_{nc} {C}_{4} & \end{matrix}$$

The units of the parameters in the formula are the same as those in the above formulas; in addition, the terms in the above formula respectively represent growth, death, and particle settling. Wherein:

$${D}_{P 1} = {k}_{1 R} {θ}_{1 R}^{( T - 20 )} + {k}_{1 D} + {k}_{1 G} Z ( t )$$

$${G}_{P 1} = {k}_{1 C} {X}_{RTj} {X}_{RIj} {X}_{RNj}$$

$$\begin{matrix}Phytoplankton phosphorus cycle & \\ \frac{\partial {C}_{4} {a}_{pc}}{\partial t} = {G}_{p 1} {a}_{pc} {C}_{4} - {D}_{p 1} {a}_{pc} {C}_{4} - \frac{{V}_{s 4}}{D} {a}_{pc} {C}_{4} & \end{matrix}$$

The units of the parameters in the formula are the same as those in the above formulas; in addition, the terms in the above formula respectively represent growth, death, and particle settling.

Wherein the water quantity balance model: Q_{R}(t)=Q_{R1}(t)+Q_{R2}(t)

River segment water quantity balance model: Q_{R}(t)=Q_{R1}(t)+Q_{R2}(t)

### Backwater Area Quantity Balance Model:

$${W}_{R} ( t ) = {W}_{R} ( t - 1 ) + {W}_{R 1} ( t ) + {W}_{R 2} ( t ) - ER ( t )$$

where Q_{R}(t) [symbol] Q_{R1}(t) [symbol] Q_{R2}(t) are the flow rate of the river segment water, the replenishment flow rate of surface water within the basin, and the replenishment flow rate of reclaimed water during the t period (m³/s); W_{R}(t) [symbol] W_{R}(t−1) are the storage volumes at the beginning and end of the backwater area during the t period (m³); W_{R1}(t) [symbol] W_{R2}(t) [symbol] ER(t) are the replenishment volumes of surface water within the basin, reclaimed water, and evaporation and seepage loss volumes of the backwater area during the t period (m³/s).

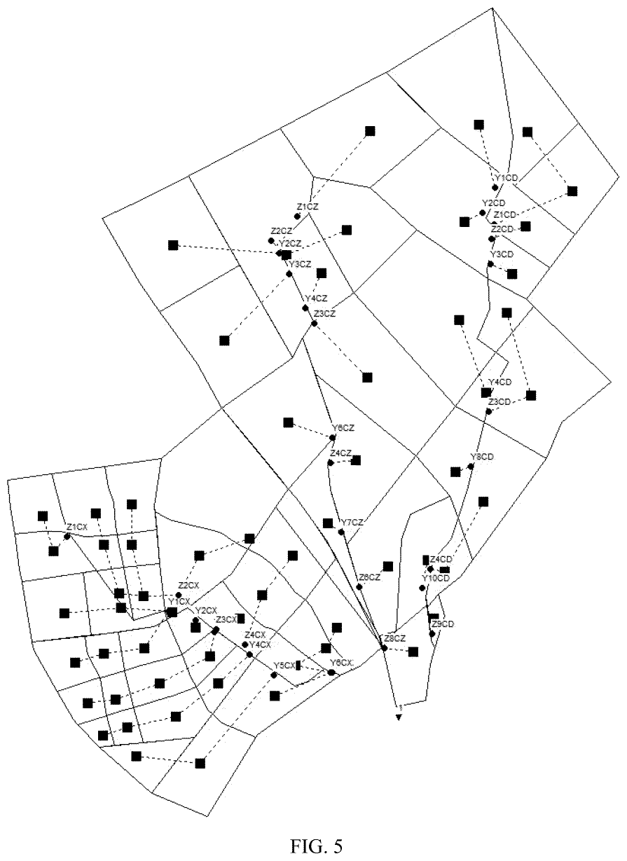

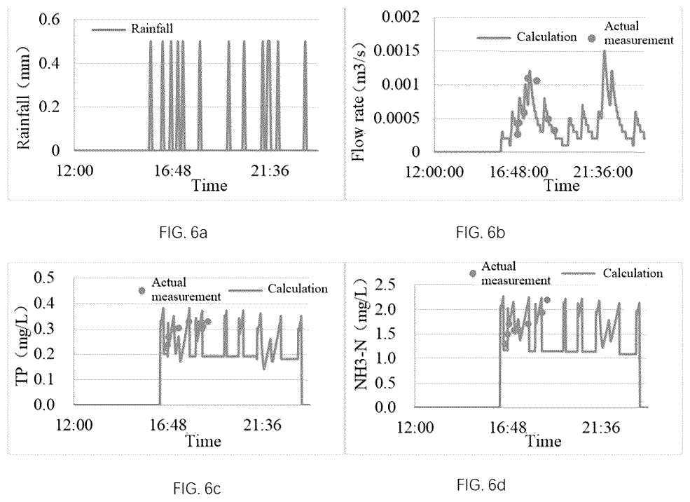

SWMM software is used to construct the watershed water resource quantity and non-point source pollution load calculation model for this basin, the watershed system generalization is shown in FIG. 5, and the model parameter validation process is shown in FIGS. 6a to 6d. In this embodiment, SWMM software is used to generalize and establish the watershed model for the river in the embodiment and to perform gridded division for water resource quantity calculations, as shown in FIG. 5. Using on-site monitoring data from the river in the embodiment, the established model is calibrated and validated, and the validation results are shown in FIGS. 6a to 6d.

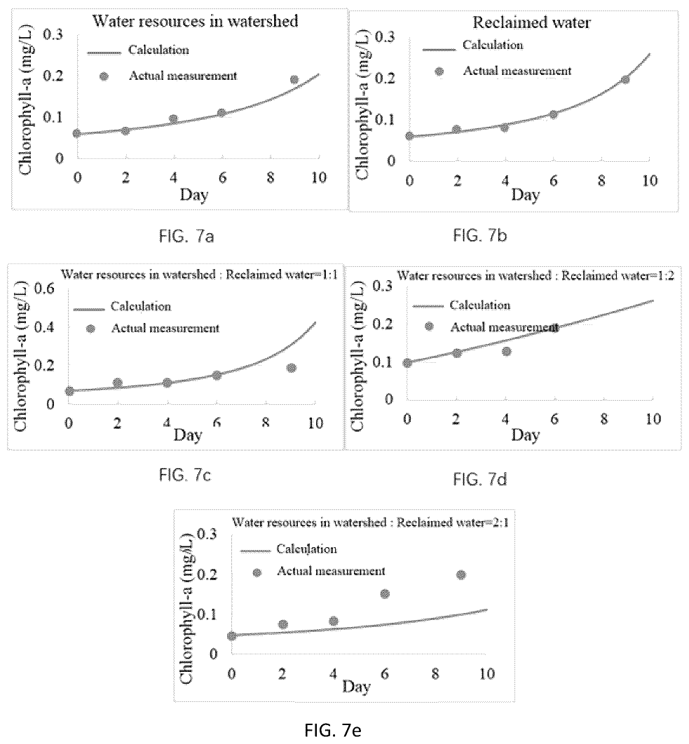

The reaction kinetics relationships among water quality indicators in WASP5 are used to simulate the spatial-temporal dynamic changes of main water quality indicators such as nitrogen, phosphorus, and chlorophyll. The model validation process is shown in FIGS. 7a to 7e. Under different proportions of source water volumes, the validation results of the spatial-temporal dynamic changes of main water quality indicators such as nitrogen, phosphorus, and chlorophyll are all satisfied, meeting model accuracy control requirements.
S3: Based on the joint regulation model for water-quantity and water-quality of the river incorporating reclaimed water, optimizing the nitrogen-phosphorus ratio of the river water environment with the indicative algae species;

Specifically, collecting natural river water source and collecting reclaimed water source; performing total nitrogen concentration and total phosphorus concentration detection on the natural river water source and the collected reclaimed water source; according to the results of the total nitrogen concentration and total phosphorus concentration detection, carrying out single water source cultivation and mixed water source cultivation of algae, obtaining algae growth curves, and simultaneously analyzing the influence of absorbance on algae growth; Considering the algae growth curves and the influence of absorbance on algae growth and combining the actual situation of a river using reclaimed water as the diversion water source, based on hydrodynamic and water quality calculation formulas, aiming at inhibiting algae growth and meeting a river water allocation volume, calculating the nitrogen-phosphorus ratio of river water and reclaimed water after mixing them in different proportions; taking nitrogen-phosphorus ratios N:P of 0:1, 5:1, 10:1, 16:1, 40:1 as standard theoretical interval values, taking N:P=16:1 and N:P=40:1 as the lower critical value and upper critical value for judging the inhibition of algal cell growth, repeating the above steps until the objectives in the objective function are achieved.

During the single water source cultivation and mixed water source cultivation processes, the cultivation conditions are set as temperature of 30° C., illumination of 2000 LUX, and light-dark ratio of 12 h: 12 h.
S4: Based on the optimized nitrogen-phosphorus ratio, optimizing the joint regulation model for water-quantity and water-quality of the river incorporating reclaimed water;

Specifically, after model validation, taking the algae risk control objective, river flow or water quantity, usable quantity constraint of surface water resources within the basin, and usable quantity constraint of the reclaimed water as control conditions, optimization is carried out for the river water-quantity and water-quality joint regulation incorporating reclaimed water in the river of the embodiment.
S5: Utilizing the optimized joint regulation model for water-quantity and water-quality of the river incorporating reclaimed water to perform joint regulation of water quantity and water quality.

Specifically, monitoring data are used to simulate the operation of the river landscape environment system with the optimized joint regulation model for water-quantity and water-quality of the river incorporating reclaimed water, the simulated operation results are compared with the monitoring data, and when the deviation is less than a second threshold (for example, 10%), the model is considered feasible, otherwise returning to parameter calibration.

Under the conditions of this embodiment, the response relationship between different reclaimed water allocation flow rates and chlorophyll-a in the object river is shown in Table 1.

TABLE 1
Chlorophyll-a concentration at monitoring cross-sections and response
time under different reclaimed water allocation flow rates

| | | | | | | Time |
|---|---|---|---|---|---|---|
| Reclaimed | Maximum | | Minimum | | Chlorophyll-a | required for |
| water | chlorophyll-a | Time to | chlorophyll-a | Time to | concentration | chlorophyll-a |
| allocation | concentration | maximum | concentration | minimum | difference | improvement |
| flow (m³/s) | (mg/L) | value (d) | (mg/L) | value (d) | (mg/L) | (d) |
| 0.10 | 0.061 | 0.96 | 0.008 | 2.04 | 0.053 | 1.08 |
| 0.20 | 0.060 | 0.58 | 0.008 | 1.13 | 0.052 | 0.55 |
| 0.30 | 0.059 | 0.42 | 0.008 | 0.79 | 0.051 | 0.37 |
| 0.35 | 0.059 | 0.38 | 0.008 | 0.71 | 0.051 | 0.33 |
| 0.40 | 0.059 | 0.33 | 0.008 | 0.63 | 0.051 | 0.30 |
| 0.52 | 0.059 | 0.29 | 0.008 | 0.50 | 0.051 | 0.21 |

### Joint Regulation Strategy for Water Quantity and Water Quality:

Main influencing factors: precipitation conditions and reclaimed water quality conditions. On one hand, precipitation brings short-duration input of non-point source pollution, leading to short-duration deterioration of river water quality; on the other hand, rainwater inflow causes an increase in river water volume and a rise in water level, supplementing the shortage of river landscape environment water. Reclaimed water quantity and quality conditions: due to treatment technology reasons, the effluent quality of the reclaimed water plant fluctuates to a certain extent between seasons.

Regulation strategy: a multi-objective and multi-scenario regulation strategy with dual control of water quantity and water quality as the goal, full-process perception data as the basis, and precipitation-based reclaimed water regulation as the means.

Medium- and long-term regulation plan within the basin: when the water level at the monitoring control point of the river is below 57.77 m, reclaimed water allocation is initiated; when the control point water level reaches 57.77 m or above, if the effluent quality is worse than the baseline value, water diversion is stopped for the day; after the effluent quality becomes better than the baseline value, water allocation is initiated again. Under rainfall conditions, when the water level at the monitoring control point of the river exceeds 58.23 m, water allocation is stopped; after rainfall stops and the water level falls below 57.8 m, water allocation is initiated again.

From the above embodiments, it can be seen that the present disclosure overcomes technical issues such as river water quality degradation and abnormal algae reproduction that may occur after reclaimed water is used for river landscape environment water allocation, while utilizing reclaimed water to supplement seasonal river landscape environment water, thereby achieving the technical effects of rational allocation and precise regulation of multi-source water for seasonal rivers.

Those skilled in the art will readily conceive of other embodiments of the present disclosure after considering the description and practicing the content disclosed herein. The present disclosure is intended to cover any modifications, uses, or adaptive changes of the present disclosure, which follow the general principles of the present disclosure and include common knowledge or conventional technical means in the technical field not disclosed in the present disclosure. The description and embodiments are to be regarded as illustrative only, and the true scope and spirit of the present disclosure are indicated by the appended claims.

It should be understood that the present disclosure is not limited to the precise structures described above and shown in the drawings, and various modifications and changes can be made without departing from its scope. The scope of the present disclosure is limited only by the appended claims.

What is claimed is:

1. A water distribution regulation method for reclaimed waterway landscape environment based on algae risk control, comprising:
according to water source characteristics of seasonal river landscape environment water and hydraulic characteristics of river water, based on a algae growth curve of indicative algae species, controlling algae risk with a nitrogen-phosphorus ratio and a water replacement rate as control indicators, the nitrogen-phosphorus ratio serving as the control indicator for a free-flow segment of the river and the water replacement rate serving as the control indicator for a backwater segment of the river regulated by an overflow weir dam;
based on the nitrogen-phosphorus ratio and the water replacement rate, constructing a joint regulation model for water-quantity and water-quality of the river incorporating reclaimed water, the joint regulation model for water-quantity and water-quality of the river incorporating reclaimed water being composed of an objective function and constraint conditions, the objective function including an algae risk control objective and a river flow or water quantity objective, the constraint conditions including a usable quantity constraint of surface water resources within a basin and a usable quantity constraint of the reclaimed water;
based on the joint regulation model for water-quantity and water-quality of the river incorporating reclaimed water, optimizing the nitrogen-phosphorus ratio of the river water environment with the indicative algae species;
based on the optimized nitrogen-phosphorus ratio, optimizing the joint regulation model for water-quantity and water-quality of the river incorporating reclaimed water;
utilizing the optimized joint regulation model for water-quantity and water-quality of the river incorporating reclaimed water to perform joint regulation of water quantity and water quality;
wherein:
the algae risk control objective is:
$$α = \frac{{D}_{TN}}{{D}_{TP}} = [ {α}_{1} , {α}_{2} ] ;$$
$$T = \frac{{W}_{0}}{{w}_{1} + {w}_{2}} = [ {T}_{1} , {T}_{2} ] ;$$
where a is a nitrogen-phosphorus ratio in the river segment water; [symbol] D_{TP} are a total nitrogen concentration and a total phosphorus concentration values in the river segment water, respectively; [symbol] α₃ are a lower limit and a upper limit of a reasonable interval of the nitrogen-phosphorus ratio for controlling algae growth; T is a water replacement period of the backwater area; W₀ is a volume of the backwater area; [symbol] w₂ are respectively unit-time replenishment volumes of surface water within the basin and the reclaimed water for the backwater area; [symbol] T₂ are respectively a lower limit and upper limit of the reasonable interval for the water replacement period of the backwater area;
the river flow or water quantity objective is:
$$\begin{matrix}{Q}_{R} \geq {Q}_{OBJ} = max [ {Q}_{L} , {Q}_{E} ] ; \\ {w}_{R} \geq {w}_{OBJ} = max [ {w}_{L} , {w}_{E} ]\end{matrix}$$
where Q_{R} is a flow rate of the river segment water; Q_{OBJ} is a target flow rate of the river segment water; [symbol] Q_{E} are a landscape flow rate and an environmental flow rate of the river segment water, respectively; w_{R} is a water level of the backwater area; w_{OBJ} is a target water level of the backwater area; [symbol] w_{E} are respectively a landscape water level and an environmental water level of the backwater area;
the usable quantity constraint of surface water resources within the basin and the usable quantity constraint of the reclaimed water are respectively:
usable quantity constraint of surface water resources within the basin:
$${Q}_{R 1} ( t ) \leq {Q}_{R 1}^{0} ( t )$$
usable quantity constraint of the reclaimed water:
$${Q}_{R 2} ( t ) \leq {Q}_{R 2}^{0} ( t ) ;$$
where Q_{R1}(t) [symbol] Q_{R2}(t) are respectively a replenishment flow rates of surface water within the basin and a reclaimed water during the t period;
$${Q}_{R 1}^{0} ( t ) , {Q}_{R 2}^{0} ( t )$$
are respectively a upper limits of the usable quantities of surface water within the basin and a reclaimed water during the t period;
when solving the objective function, it is necessary to use three models consisting of a watershed water resource quantity and a non-point source pollution load calculation model, a river water quality and ecological coupling model, and a water quantity balance model, the three models being constrained by the constraint conditions, wherein the watershed water resource quantity and non-point source pollution load calculation model is constructed using SWMM software, and the river water quality and ecological coupling model and the water quantity balance model are constructed using WASP5;
employing SWMM software to calibrate parameters of the established watershed water resource quantity and non-point source pollution load model using monitoring data;
employing WASP5 software to calibrate parameters of the established river water quality and ecological coupling model using monitoring data until a difference between the simulated and calculated values of the model and the monitoring values is less than a first threshold;
for the watershed water resource quantity and non-point source pollution load calculation model:
the watershed water resource quantity model characterizing the inflow process of runoff generated from each sub-basin converging to a stormwater outlet, using a non-linear reservoir model to describe a surface runoff process, each sub-catchment being generalized as a shallow non-linear reservoir, rainfall as input, soil infiltration and surface runoff as output, solved jointly by a continuity equation and a Manning's formula:
$$\begin{matrix}\frac{dV}{dt} = A * \frac{dd}{dt} = A * {i}^{′} - {Q}_{0} \\ {Q}_{0} = W * \frac{1.49}{n} * {( d - {d}_{p} )}^{5 / 3} * {S}^{1 / 2}\end{matrix}$$
where V is a total water volume of the sub-catchment (m³); d is a surface water depth of the sub-catchment (m); A is an area of the sub-catchment (m²); t is a rainfall time(s); i′ is a net rainfall intensity (mm); Qₒ is a runoff flow rate (m³/s); W is a characteristic width of the sub-catchment (m); n is a Manning coefficient; S is a slope of the sub-catchment;
the non-point source pollution load model characterizes non-point source pollution generated by rainfall runoff within the watershed, solved by a following equation:
$${M}_{0} = {Q}_{0} {C}_{0}$$
where Mₒ is a total non-point source pollution load of a specific pollutant in the area (t); Cₒ is a concentration of non-point source pollution of a specific pollutant in the area (mg/L).
for the river water quality and ecological coupling model:
the river water quality and ecological model uses following equations to solve for main indicators respectively:
$$Carbonaceous biochemical oxygen demand : \frac{\partial {C}_{5}}{\partial t} = {a}_{oc} {k}_{ID} {C}_{4} - {k}_{d} {θ}_{d}^{( T - 20 )} ( \frac{{C}_{6}}{{K}_{BOD} - {C}_{6}} ) {C}_{5} - \frac{{v}_{s 3} ( 1 - {f}_{D 5} )}{H} {C}_{5} - \frac{5}{4} \frac{32}{14} {k}_{2 D} {θ}_{2 D}^{( T - 20 )} ( \frac{{k}_{{NO}_{3}}}{{k}_{{NO}_{3}} + {C}_{6}} ) {C}_{2} 6 + \frac{{v}_{s 3} ( 1 - {f}_{D 5} )}{D} {C}_{5} - \frac{{v}_{R 3} ( 1 - {f}_{D 5 j} )}{D} {C}_{5 j} + \frac{{E}_{DIF}}{{D}^{2}} ( {C}_{5} {f}_{D 5} - {C}_{5 j} {f}_{D 5 j} )$$
where C is a concentration of a specific indicator (mg/L), t is time(s), k is a mineralization rate of the specific indicator, K is a diffusion coefficient of the specific indicator (m²/s), θ is a temperature coefficient of the specific indicator (° C./s), f is a dissolution rate of the specific indicator (mol/L), BOD is biochemical oxygen demand (mg/L); in addition, the terms in the above formula respectively represent phytoplankton death, carbon oxidation, particle settling, denitrification, organic matter settling, suspension, and dispersion.
$$Dissolved oxygen : \frac{\partial {C}_{6}}{\partial t} = {k}_{2} ( {C}_{s} - {C}_{6} ) - {k}_{d} {θ}_{d}^{( T - 20 )} ( \frac{{C}_{6}}{{K}_{BOD} + {C}_{6}} ) {C}_{5} - \frac{64}{14} {k}_{12} {θ}_{12}^{( T - 20 )} ( \frac{{C}_{6}}{{k}_{NIT} + {C}_{6}} ) {C}_{1} - \frac{SOD}{H} {θ}_{S}^{( T - 20 )} + {G}_{P 1} [ \frac{32}{12} + \frac{48}{14} \frac{14}{12} ( 1 - {P}_{NH 3} ) ] {C}_{4} - \frac{32}{12} {k}_{1 R} {θ}_{1 R} {C}_{4}$$
units of parameters in the formulas are the same as those in the above formulas, in addition, the terms in the above formula respectively represent reoxygenation, carbon oxidation, nitrification, sediment oxygen demand, growth, and respiration;
$$Ammonia nitrogen cycle equation : \frac{\partial {C}_{1}}{\partial t} = {D}_{P 1} {a}_{NC} ( 1 - {f}_{ON} ) {C}_{4} + {k}_{71} {θ}_{71}^{( T - 20 )} ( \frac{{C}_{4}}{{k}_{mpc} + {C}_{4}} ) {C}_{7} - {G}_{P 1} {a}_{NC} {P}_{NH 3} {C}_{4} - {k}_{12} {θ}_{12}^{( T - 20 )} ( \frac{{C}_{6}}{{k}_{NIT} + {C}_{6}} ) {C}_{1}$$
units of parameters in the formula are the same as those in the above formulas, in addition, the terms in the above formula respectively represent phytoplankton death, mineralization, phytoplankton growth, and nitrification;
$$Nitrate nitrogen cycle equation : \frac{\partial {C}_{2}}{\partial t} = {k}_{12} {θ}_{12}^{( T - 20 )} ( \frac{{C}_{6}}{{k}_{NIT} + {C}_{6}} ) {C}_{1} - {G}_{P 1} {a}_{NC} ( 1 - {P}_{NH 3} ) {C}_{4} - {k}_{2 D} {θ}_{2 D}^{( T - 20 )} ( \frac{{k}_{NO 3}}{{k}_{NO 3} + {C}_{4}} ) {C}_{2}$$
units of parameters in the formula are the same as those in the above formulas, in addition, the terms in the above formula respectively represent nitrification, phytoplankton growth, and denitrification;
$$Organic nitrogen cycle equation : \frac{\partial {C}_{7}}{\partial t} = {D}_{P 1} {a}_{NC} {f}_{ON} {C}_{4} - {k}_{71} {θ}_{71}^{( T - 20 )} ( \frac{{C}_{4}}{{k}_{mpc} + {C}_{4}} ) {C}_{7} - \frac{{v}_{s 3} ( 1 - {f}_{D 7} )}{H} {C}_{7}$$
units of parameters in the formula are the same as those in the above formulas, in addition, the terms in the above formula respectively represent phytoplankton death, mineralization, and organic matter deposition.
$$Inorganic phosphorus ( {PO}_{4} ) cycle : \frac{\partial {C}_{3}}{\partial t} = {D}_{P 1} {a}_{PC} ( 1 - {f}_{OP} ) {C}_{4} + {k}_{83} {θ}_{83}^{( T - 20 )} ( \frac{{C}_{4}}{{k}_{mpc} + {C}_{4}} ) {C}_{8} - {G}_{p 1} {a}_{pc} {C}_{4}$$
units of parameters in the formula are the same as those in the above formulas, in addition, the terms in the above formula respectively represent phytoplankton death, mineralization, and phytoplankton growth;
$$Organic phosphorus ( OP ) cycle : \frac{\partial {C}_{8}}{\partial t} = {D}_{P 1} {a}_{PC} {f}_{OP} {C}_{4} + {k}_{83} {θ}_{83}^{( T - 20 )} ( \frac{{C}_{4}}{{k}_{mpc} + {C}_{4}} ) {C}_{8} - \frac{{v}_{s 3} ( 1 - {f}_{D 8} )}{H} {C}_{8}$$
units of parameters in the formula are the same as those in the above formulas, in addition, the terms in the above formula respectively represent phytoplankton death, mineralization, and deposition;
$$Phytoplankton nitrogen cycle : \frac{\partial {C}_{4} {a}_{nc}}{\partial t} = {G}_{p 1} {a}_{nc} {C}_{4} - {D}_{p 1} {a}_{nc} {C}_{4} - \frac{{V}_{s 4}}{D} {a}_{nc} {C}_{4}$$
units of parameters in the formula are the same as those in the above formulas, in addition, the terms in the above formula respectively represent growth, death, and particle settling, and:
$${D}_{P 1} = {l}_{1 R} {θ}_{1 R}^{( T - 20 )} + {k}_{1 D} {k}_{1 G} Z ( t )$$
$${G}_{P 1} = {k}_{1 C} {X}_{RTj} {X}_{RIj} {X}_{RNj}$$
$$Phytoplankton phosphorus cycle : \frac{\partial {C}_{4} {a}_{pc}}{\partial t} = {G}_{p 1} {a}_{pc} {C}_{4} - {D}_{p 1} {a}_{pc} {C}_{4} - \frac{{V}_{s 4}}{D} {a}_{pc} {C}_{4}$$
units of parameters in the formula are the same as those in the above formulas, in addition, the terms in the above formula respectively represent growth, death, and particle settling;
and for the water quantity balance model:
river segment water quantity balance model: Q_{R}(t)=Q_{R1}(t)+Q_{R2}(t)
backwater area quantity balance model: W_{R}(t)=W_{R}(t−1)+W_{R1}(t)+W_{R2}(t)−ER(t) where Q_{R}(t) [symbol] Q_{R1}(t) [symbol] Q_{R2}(t) are respectively a flow rate of the river segment water, a replenishment flow rate of surface water within the basin, and a replenishment flow rate of reclaimed water during the t period (m³/s); W_{R}(t) [symbol] W_{R}(t−1) are respectively storage volumes at a beginning and an end of the backwater area during the t period (m³);
W_{R1}(t) [symbol] W_{R2}(t) [symbol] ER(t) are respectively replenishment volumes of surface water within the basin, reclaimed water, and evaporation and seepage loss volumes of the backwater area during the t period (m³/s).

2. The water distribution regulation method for reclaimed waterway landscape environment based on algae risk control according to claim 1, wherein solving the objective function further comprising steps of: using monitoring data to simulate the operation of the river landscape environment system with the optimized joint regulation model for water-quantity and water-quality of the river incorporating reclaimed water, comparing the simulated operation results with the monitoring data, and considering the model being feasible when the deviation is less than a second threshold, otherwise returning to parameter calibration.

3. The water distribution regulation method for reclaimed waterway landscape environment based on algae risk control according to claim 1, wherein based on the joint regulation model for water-quantity and water-quality of the river incorporating reclaimed water, optimizing the nitrogen-phosphorus ratio of the river water environment with the indicative algae species comprises:
collecting natural river water source and collecting reclaimed water source;
performing total nitrogen concentration and total phosphorus concentration detection on the natural river water source and the collected reclaimed water source;
according to the results of the total nitrogen concentration and total phosphorus concentration detection, carrying out single water source cultivation and mixed water source cultivation of algae, obtaining algae growth curves, and simultaneously analyzing the influence of absorbance on algae growth;
considering the algae growth curves and the influence of absorbance on algae growth, combining the actual situation of a river using reclaimed water as the diversion water source, based on hydrodynamic and water quality calculation formulas, aiming at inhibiting algae growth and meeting a river water allocation volume, calculating the nitrogen-phosphorus ratio of river water and reclaimed water after mixing them in different proportions;
taking nitrogen-phosphorus ratios N:P of 0:1, 5:1, 10:1, 16:1, 40:1 as standard theoretical interval values, taking N:P=16:1 and N:P=40:1 as the lower critical value and upper critical value for judging the inhibition of algal cell growth, repeating the above steps until the targets in the objective function are achieved.

4. The water distribution regulation method for reclaimed waterway landscape environment based on algae risk control according to claim 1, wherein during the single water source cultivation and mixed water source cultivation processes, the cultivation conditions are set as temperature of 30° C., illumination of 2000 LUX, and a light-dark ratio of 12 h:12 h.
